(19) United States
(12) Patent Application Publication
(10) Pub. No.: US 2025/0091552 A1
(43) Pub. Date: Mar. 20, 2025

(54) Vehicle Wash System

(71) Applicant: James Patrick Ordo, Avon, IN (US)

(72) Inventor: James Patrick Ordo, Avon, IN (US)

(21) Appl. No.: 18/967,470

(22) Filed: Dec. 3, 2024

Related U.S. Application Data
(63) Continuation-in-part of application No. 17/244,360, filed on Apr. 29, 2021, now Pat. No. 12,162,443.
(63) Continuation-in-part of application No. 17/500,482, filed on Oct. 13, 2021, now Pat. No. 12,157,441.
(60) Provisional application No. 63/017,337, filed on Apr. 29, 2020.
(60) Provisional application No. 63/092,749, filed on Oct. 16, 2020.

(51) Int. Cl. B60S 3/00; B60S 3/04

(52) U.S. Cl. CPC B60S 3/004; B60S 3/04

(57) ABSTRACT

A vehicle wash system is provided.

### RELATED APPLICATIONS

This application claims priority to U.S. Non-Provisional patent application Ser. No. 17/244,360, filed Apr. 29, 2021, to James P. Ordo, title “VEHICLE WASH SYSTEM”, which claims priority to U.S. Provisional Patent Application No. 63/017,337, filed Apr. 29, 2020, to James P. Ordo, title, “CARWASH RECLAIM SYSTEM” and this application claims priority to U.S. Non-Provisional patent application Ser. No. 17/500,482, now U.S. Pat. No. 12,157,441, filed Oct. 13, 2021, to James P. Ordo, titled “VEHICLE WASH REVERSE OSMOSIS SYSTEM”, which claims the benefit of U.S. Provisional Patent Application No. 63/092,749, filed Oct. 16, 2020, to James P. Ordo, titled “CARWASH RECLAIM SYSTEM”, the entire disclosures of which is expressly incorporated by reference herein.

### TECHNICAL FIELD

The present disclosure generally relates to a vehicle wash system. More particularly, the present disclosure relates to a vehicle wash system including a reclamation loop, a filtration system, and an oxidizer system.

### BACKGROUND AND SUMMARY OF THE DISCLOSURE

This section introduces aspects that may help facilitate a better understanding of the disclosure. Accordingly, these statements are to be read in this light and are not to be understood as admissions about, what is or is not prior art.

There are over 17,000 conveyor-type vehicle wash systems in the U.S. market alone. Current vehicle wash systems use about 45 gallons per car. However, using a liquid reclamation system, a vehicle wash system can save 10-20 gallons of water per car based on the 45 gallon per car usage. Some vehicle wash systems use liquid reclamation systems to collect liquid used to wash vehicle and recycle the liquid by removing cleaning chemicals and material such as dirt, oil, leaves, paper and other organic materials. While collecting, filtering, sanitizing, and storing the liquid in the liquid reclamation system, this liquid can turn anaerobic, causing unpleasant smells, and can remain too turbid, clogging nozzles or damaging pumps.

According to one aspect of the present disclosure, a vehicle wash system is provided. The vehicle wash system comprises a plurality of nozzles configured to apply liquids to vehicles, a vehicle conveyor configured to advance vehicles past the plurality of nozzles, a basin positioned below the vehicle conveyor to collect liquids applied to the vehicle, and at least one pump configured to pump liquids to the plurality of nozzles. The at least one pump is configured to pump the liquids collected by the basin after application to the vehicles by the plurality of nozzles. The system further comprises an outlet positioned to provide liquids from the at least one pump directly to the basin.

According to another aspect of the present disclosure, a vehicle wash system is provided. The vehicle wash system comprises a plurality of nozzles configured to apply liquids to vehicles, a vehicle conveyor configured to advance vehicles past the plurality of nozzles, a basin positioned below the vehicle conveyor to collect liquids applied to the vehicle, and at least one pump configured to pump liquids to the plurality of nozzles. The at least one pump is configured to pump the liquids collected by the basin after application to the vehicles by the plurality of nozzles. The system further comprises a bypass providing liquids from the at least one pump to the basin, bypassing the plurality of nozzles.

According to another embodiment of the present disclosure, a vehicle wash system is provided. The vehicle wash system comprises a plurality of nozzles configured to apply liquids to vehicles, a vehicle conveyor configured to advance vehicles past the plurality of nozzles at a vehicle rate, and at least one pump configured to pump liquids to the plurality of nozzles. The at least one pump is configured to pump the liquids from at least one tank positioned to receive the liquids after application to the vehicles by the plurality of nozzles. The system further comprises an adjustable oxidizer system in fluid communication with the liquids moved by the at least one pump to introduce a metered amount of oxidizer into the liquid and adjusting the metering based on the vehicle rate.

### BRIEF DESCRIPTION OF THE DRAWINGS

The previously described aspects of this disclosure will grow to be appreciated at a greater level once references to the following accompanying illustrations are expounded upon.

FIG. 1 is a schematic diagram of a vehicle wash system having a vehicle conveyor, a basin positioned under the vehicle conveyor to collected liquid, at least one tank receiving liquid from the basin, an oxidizer system, a recirculation loop including the basin to recirculate water, and a reclamation loop including a filtration system and nozzles

FIG. 2 is the schematic diagram of another vehicle wash system similar to the vehicle wash system of FIG. 1 showing the vehicle wash system with a series of tanks including three tanks and a filtration system having a filter and a buffer tank;

FIG. 3 is an enlarged view of an alternative embodiment basin showing a sloped basin;

FIG. 4 is a cross-sectional view of the basin taken along line 4-4 of FIG. 3 showing tapered sides of the basin;

FIG. 5 is an enlarged view of an alternative embodiment filtration system showing a filter, a buffer tank, at least one municipal, water feed, a municipal sewer drain, and a plurality of pressure gauges and switches;

FIG. 6 is an enlarged view of an alternative embodiment filtration system showing additional details of the series of tanks and further showing a first tank having a water inlet, a second tank having an aerator, and a third tank having at least one pump;

FIG. 7 is the schematic diagram of another vehicle wash system similar to the vehicle wash system of FIG. 1 showing the vehicle wash system with a basin similar to the basin of FIG. 3, a filtration system similar to the filtration system of FIG. 5, and a series of tanks similar to the series of tanks of FIG. 6; and

FIG. 8 is a top view of a vehicle wash system having a conveyor, nozzles, wraps, and air dryers; and

FIG. 9 is a graph showing the rate of dosing decreasing with vehicle rates and the rate of municipal water and reclamation water usage increasing with vehicle rates.

The embodiments disclosed below are not intended to be exhaustive or limit the disclosure to the precise form disclosed in the following detailed description. Rather, the embodiments are chosen and described so that others skilled in the art may utilize their teachings. Unless otherwise indicated, the components shown in the figures are shown proportional to each other. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

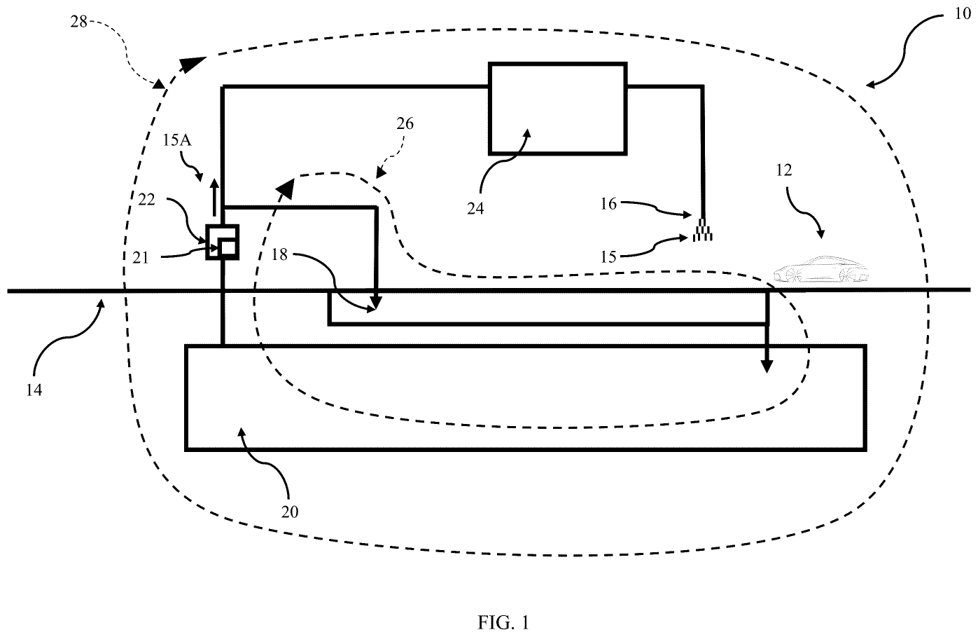

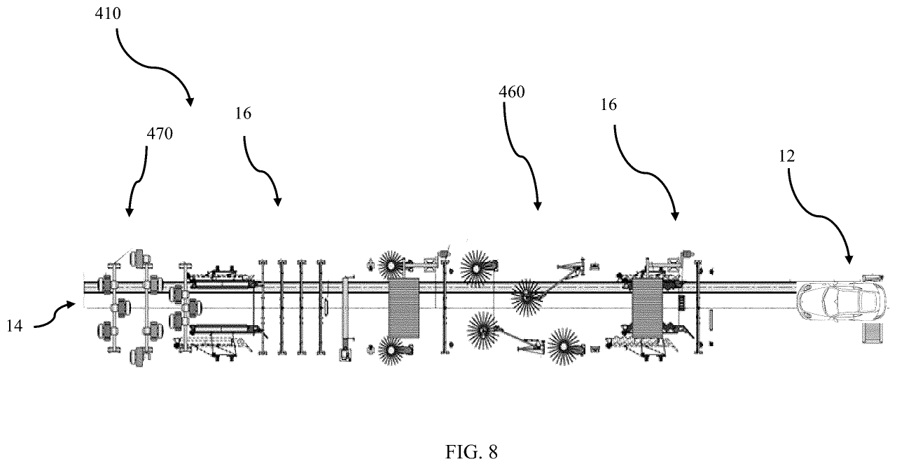

As shown in FIG. 1, a vehicle wash system 10 is provided to wash vehicles 12. Wash system 10 includes a conveyor system 14 to advance vehicles 12 through wash system 10 and a plurality of nozzles 16 that apply liquids 15 to vehicles 12 as they are advanced past nozzles 16 by conveyor system 14. Additional details of other components suitable for use with wash system 10 and the other wash systems described herein are provided in FIG. 8 and described herein.

Wash system 10 also includes a basin 18 that collects liquids 15 applied to vehicles 12 and other liquids and materials that fall into or are otherwise collected by basin 18. A series of tanks 20 receive liquids 15 and other materials, such as paper, fibers, etc., collected by basin 18 and pumped to an oxidation system 22 that introduces one or more oxidizers into liquids 15 to create oxidized liquids 15A.

Oxidizer system 22 may include a feedback control loop having at least one sensor 21. At least one sensor 21 measures a characteristic of liquids 15, such as temperature, dissolved oxygen saturation, pH, etc., and oxidizer system 22 adjusts the introduction of oxidizer into liquids 15 based on the measured characteristic. The one or more oxidizers are introduced to increase the dissolved oxygen in liquids 15 throughout vehicle wash system 10. Measured characteristics of liquids 15 are used by the PLC to adjust the dosing of liquids 15 with oxidizers. Additionally, the PLC may provide warnings if certain characteristics are above or below preferred levels, such as the pH of the liquids going below 6.0 pH, etc.

After leaving oxidation system 22, oxidized liquids 15A is directed to either plurality of nozzles 16 or oxidized liquids 15A bypasses nozzles 16 and is directed to basin 18. Oxidized liquids 15A directed to nozzles 16 passes through a filter 24 to remove materials prior to being applied to vehicles 12 by nozzles 16.

Together, basin 18, series of tanks 20 and oxidizer system 22 cooperate to provide a recirculation loop 26. Similarly, basin 18, series of tanks 20, oxidizer system 22, filter 24, and nozzles 16 cooperate to provide a reclamation loop 28. Components may be added or removed from either loop 26, 28.

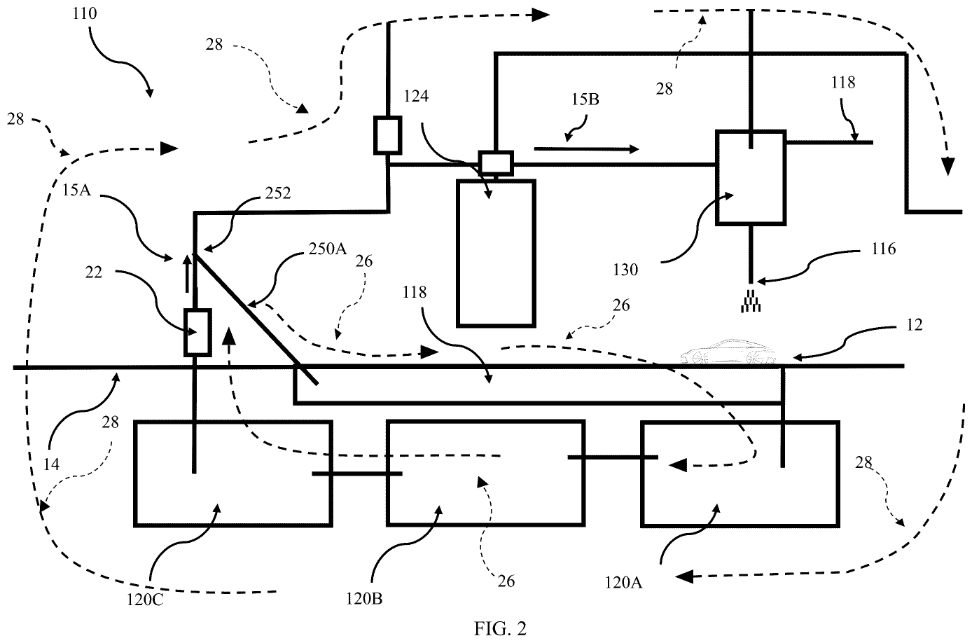

As shown in FIG. 2, a vehicle 1 wash system 110 is provided that is similar to vehicle wash system 10 of FIG. 1. Wash system 110 includes a buffer tank 130 positioned downstream of a filter 124 and upstream of nozzles 16, to store liquids 15 that have been oxidized by oxidizer system 22 and filtered by filter 124, creating filtered liquids 15B, and a series of tanks 120A, 120B, 120C to receive liquids and other material collected by a basin 118.

Filter 124 has a preferred tank volume of about 180 gallons and a flow rate of about 20-30 gallons of oxidized liquid 15A per minute flowing there through when in a reclamation mode with liquid 15A flowing through reclamation loop 28. At 30 gallons per minute, this provides a filter tank volume to flow rate ratio of six minutes, allowing oxidized liquid six minutes to flow through filter 124. According to alternative embodiments, the ratio may be one minute, two minutes, four minutes, eight minutes, ten minutes, etc. When in a recirculation mode with liquid 15A flowing through recirculation loop 26, the flow rate of liquid 15A is about 80-85 gallons per minute.

Wash system 110 and the other systems described herein, may include a flow path/bypass 250A that directs oxidized liquid 15A directly to basin 218. Junction 252 splits or divides oxidized water 15A so that a portion or all of oxidized liquids 15A travels to filter 124 and ultimately to nozzles 16 and another portion or all of oxidized liquids 15A bypasses filter 124 and nozzles 16.

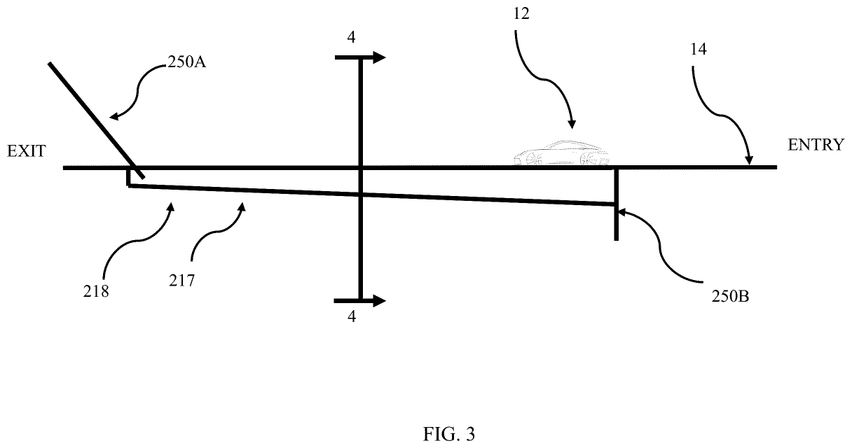

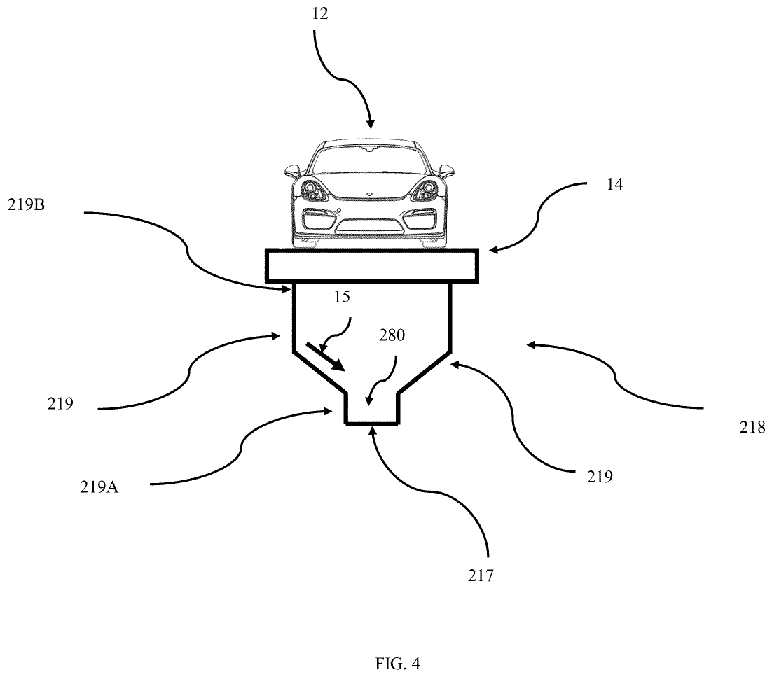

FIGS. 3 and 4 shows one embodiment of a basin 218 having a basin bottom 217 and basin sides 219. Basin bottom 217 is sloped to direct liquids 15 and materials, such as sand, dirt, etc. that fall into or are otherwise collected by basin 218 toward a basin outlet 250B. As shown in FIG. 4, conveyor 14 is a belt conveyor and basin 218 are about the same width or greater than the width of vehicle 12. Conveyor 14 is wider than basin 218 and each of conveyor 14 and basin 218 are substantially wider than one half of the width of vehicle 12. According to alternative embodiments of the present disclosure, conveyor 14 and basin 218 are other widths relative to vehicle 12, such as greater than one quarter of the width of vehicle 12, greater than three quarters of the width of vehicle 12, etc. According to another embodiment, conveyor 14 may be a chain conveyor with a width slightly wider than vehicle tires (see for example FIG. 8).

Basin sides 219 are tapered such that lower ends 219A of basin sides 219 are substantially closer together than upper ends 219B of sides 219. Lower ends 219A of sides 219 cooperate to define basin trough 280. According to basin 218, basin sides 219 include a tapered segment of the height of basin sides 219. According to other embodiments, basin sides 219 may be substantially tapered for the entire height. According to another embodiment tapered sides 219 are curved, semicircular, etc. When liquids 15 and materials are collected by basin 218, tapered basin sides 219 direct liquids 15 and materials into a basin trough 280 and down basin bottom 217. According to the present disclosure, basin trough 280 has a rectangular shape as shown. According to other embodiments, basin trough 280 may have curved sides, etc. As shown in FIG. 3, the height of basin 218 increases along the length of basin 218 from a shortest height/high end on the vehicle exit end and a tallest height/low end on the vehicle entry end. Tapered basin sides 219 preferably extend the entire length of basin 218.

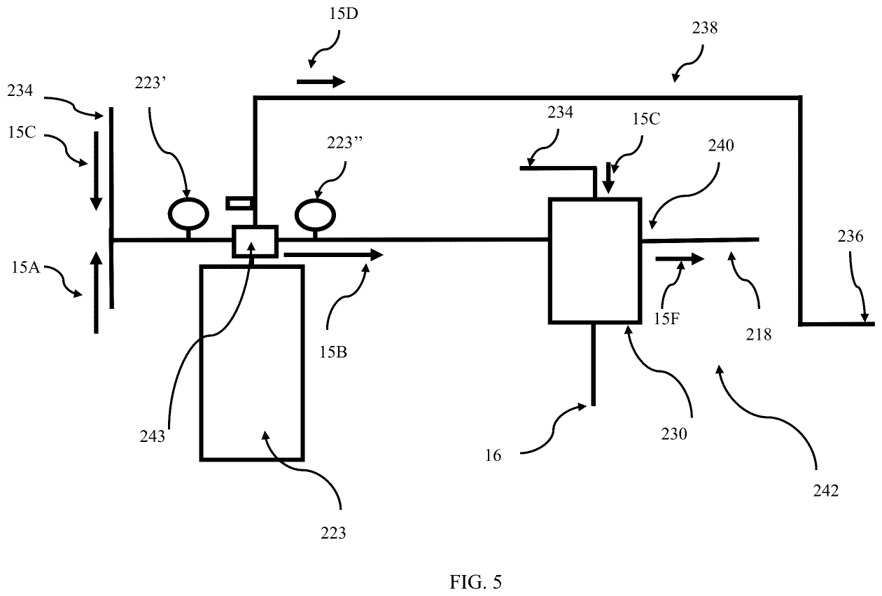

FIG. 5 shows one embodiment of a filtration system 242 having a filter 224 and a buffer tank 230. Filter 224 removes materials from liquids 15, including neutrally buoyant materials, to create filtered liquids 15B. According to this filtration system 242 and other filtration systems, filter 224 may be a media-based particle filter and include at least two stratum of medium. Other embodiments of a filtration system may include a mechanical filter or a cyclonic filter. After leaving filter 224, filtered liquids 15B is directed to buffer tank 230 by pipes 232, which are substantially narrower than filter 224 and buffer tank 230. Pipes 232 also have a substantially lower volume than filter 224 and buffer tank 230. Buffer tank 230 stores filtered liquids 15B before directing filtered liquids 15B to nozzles 16.

Filtration system 242 also includes pressure gauges 223′, 223″. First pressure gauge 223′ is positioned upstream of filter 224 to measure liquid pressure into filter 224. Second pressure gauge 223″ is positioned downstream of filter 224 to measure liquid pressure leaving filter 220. If liquid pressure measured by second pressure gauge 223″ is substantially lower than liquid pressure measured by first pressure gauge 223′, liquids 15C from a municipal water feed 234 are directed into filter 224. Filtration system 242 also includes a filter head 243, which is activated when backwashing is initiated to reverse the flow direction liquids 15C from municipal water feed 234 through filter 224. When filter head 243 is activated, the reversed flow of liquids 15 through filter 224 removes foreign material from the media of filter 224, creating backwashed liquids 15D. After leaving filter 224, backwashed liquids 15D and materials are directed through a sand filter drain 238 to a municipal sewer 236. After the materials have been directed through filter drain 238, filter head 243 deactivates, the flow direction of liquids 15 through filter 224 resets, and the media of filter 224 stratifies. During backwashing, different sized media may mix as the backwash water disturbs and flushes materials from the media. When the backwash water is turned off, the different sized media stratifies with finer, denser media settling to the bottom of filter 224 and coarser, less dense media settling to the top of filter 224.

Filtration system 242 also includes a municipal water feed 234 to supply additional liquids 15C, such as water, to buffer tank 230 when the level of filtered liquids 15B becomes too low, and an overflow· drain 240 directing overflow liquids 15E to municipal sewer 236 when the level of filtered liquids 15 become too high. Overflow drain 240 may also be positioned to skim oil and silicon from filtered liquids 15B in buffer tank 230. Overflow drain 240 may drain to municipal sewer 236 or may drain to basin 218. Components may be added or removed from filtration system 242. Buffer tank 230 may include one or more flow valves (not shown) that control the level of liquid 15B in buffer tank 230. One such float valve opens when tank 230 reaches a preferred minimum volume and allows municipal water into tank 230 as mentioned above.

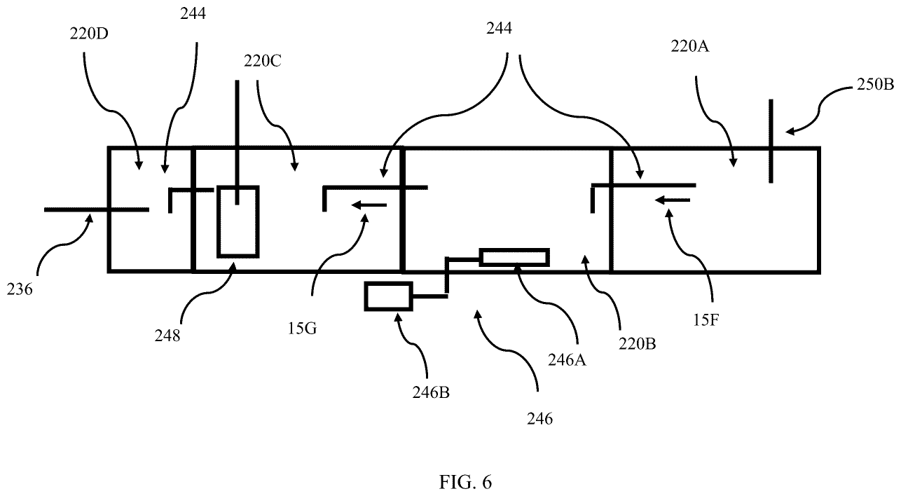

FIG. 6 shows one embodiment of a series of tanks 220 including at least three tanks 220A, 220B, 220C. Substantially all liquids 15 is received by a first tank 220A through at least one inlet 250. First tank 220A is configured to allow much of the high density material, such as sand, dirt, etc., to settle to the bottom of liquids 15, creating clarified liquids 15F. Clarified liquids 15F are then directed to a second tank 220B through a liquid path 244′.

Second tank 220B may include at least one aerator 246 configured to introduce air (not shown) into clarified liquids 15F, increasing the dissolved oxygen in clarified liquids 15F. According to the present disclosure, at least one aerator 246 comprises a porous block 246A and an air compressor 246B. According to alternative embodiments, at least one aerator 246 may be a cascade aerator, a cone aerator, a slat and coke aerator, a draft aerator, a spray aerator, a pressure aerator, a centrifugal aerator, etc. According to the present disclosure, at least one aerator 246 produces bubbles with a surface area to volume ratio greater than three, such as microbubbles, nano-bubbles, etc., creating aerated liquids 15G. Aerated liquids 15G is then directed a third tank 220C through a liquid path 244″ that includes at least one pump 248 to direct aerated liquids 15G out of series of tanks 220. According to alternative embodiment, at least one aerator 246 may be positioned in other tanks such as first tank 22A or third tank 220C.

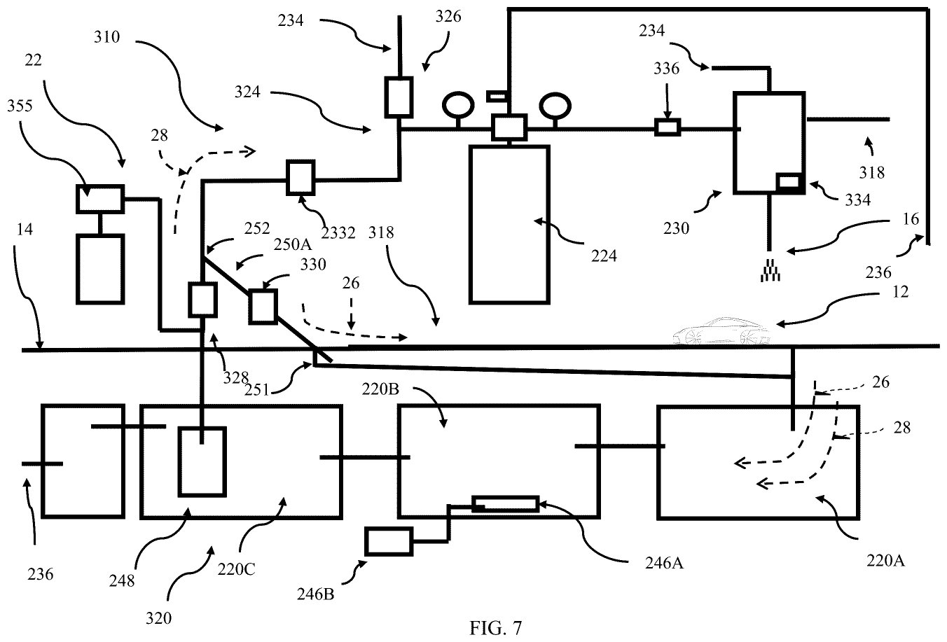

Series of tanks 220 may further include an oil and sand separator tank 220D to remove a volume of oil and sand that has settled in liquids 15 stored in series of tanks 220. Oil and sand separator tank 220D drains to a municipal sewer 236. Series of tanks 220 may comprise individually walled tanks, as shown in FIGS. 2 and 7 or may comprise tanks separated by shared walls as shown in FIG. 6. Components may be added or removed from series of tanks 220.

As shown in FIG. 7, one embodiment of a vehicle wash system 310 is provided that is similar to wash system 10 and wash system 110. Vehicle wash system 310 includes a basin 318 that is similar to basin 218, a filtration system 324 that is similar to filtration system 242, and a series of tanks 320 that is similar to series of tanks 220. Wash system 310 includes conveyor system 14 to advance vehicles 12 through wash system 310, plurality of nozzles 16 that apply liquids 15 to vehicles 12 as they are advanced past nozzles 16 by conveyor system 14, oxidation system 22 that introduces one or more oxidizers into liquids 15, recirculation loop 26, and reclamation loop 28. According to alternative embodiments, at least one aerator 246 may be positioned elsewhere in recirculation loop and reclamation loops 26, 28, such as immediately upstream or downstream of oxidation system 22.

Bypass 250A of system 310 and the other systems described herein has an outlet 251 positioned below conveyor 14 to provide liquid 15A. Outlet 251 is positioned below conveyor 14 to provide liquid 15A from the at least one pump 248 directly to basin 318 so that fluid 15 is directed down basin 318.

Control of the addition of municipal water 234 is provided by a valve 326. A flow switch 328 is provided to detect the flow of liquids 15A. If flow is not detected when flow should be occurring, the PLC will provide a warning. A valve 330 is provided to control the flow of liquids 15A directly to basin 318 when in recirculation mode. A valve 332 is provided to control the flow of liquids 15A to filter 224 when in the reclamation mode. When in the recirculation mode, valve 330 is open and valve 332 is closed. When in reclamation mode, valve 330 is closed and valve 332 is open.

As shown in FIG. 8, a vehicle wash system 410 is provided. Vehicle wash system 410 includes a conveyor system 14 to advance vehicle wash system 410, plurality of nozzle 16 to apply liquids and chemicals (not shown) to vehicles 12 as they advance past nozzles 16, plurality of wraps 460 that scrub vehicles 12 as they advance past wraps 460, and plurality of air dryers 470 that dry vehicles 12 as they advance past air dryers 470.

According to the present disclosure, oxidizer system 22, and other oxidizer systems discussed herein, the one or more oxidizers introduced into liquid 15 may be liquid oxidizer. The one or more oxidizers preferably have a half-life greater than one hour to allow for oxidizer to benefit substantially all of vehicle wash system 10, even during periods when a low volume of vehicles passes through vehicle wash system 10. To further facilitate benefiting substantially all of vehicle wash system 10, oxidizer system 22 preferably includes a dosing pump 355. While activated, dosing pump 355 continually doses metered amounts of oxidizer by filling the injector with a metered amount of oxidizer, which is then directed into liquid 15 by a piston (not shown) actuating at a metered rate. The one or more oxidizers are introduced to create oxidized liquid 15A and maintain dissolved oxygen saturation levels to keep a dissolved oxygen saturation at a level above which the hydrogen sulfide is created/released, for example, depending on the conditions, the level may be at least dissolved oxygen saturation levels may be maintained at 40%, 50%, 60%, 70%, 80%, 90%, etc. For example, liquid 15 may go anaerobic at low dissolved oxygen levels below ppm dissolved oxygen, resulting in the creation/release of hydrogen sulfide. Liquid 15 may be fully saturated around 14 ppm dissolved oxygen at 32 degrees Fahrenheit to around 7.6 ppm dissolved oxygen at 86 degrees Fahrenheit. Additional details of filtration system 324, buffer tank 230, dosing pump 355 and other components that may be incorporated into vehicle wash system 310 are provided in U.S. Non-Provisional patent application Ser. No. 17/500,482, now U.S. Pat. No. 12,157,441, and U.S. Provisional Patent Application No. 63/092,749, the disclosures of which are expressly incorporated by reference herein.

Under anerobic conditions (low levels of dissolved oxygen), sulfides cannot be oxidized so they combine with hydrogen to form hydrogen sulfide gas. This creates the “rotten egg” odor in wastewater. The formation of hydrogen sulfides is also dependent on the pH of the water with lower pH levels (<6.0) creating greater amounts of the hydrogen sulfide gas. In addition, oxygen is consumed by both the chemical oxygen demand (COD) and the biological oxygen demand (BOD).

According to the present disclosure, oxidizer system 22, and other oxidizer systems discussed herein, may include a programmable logic controller. The programmable logic controller (PLC) allows for automatic and manual adjustments of the introduction of oxidizer into liquids 15. The PLC may operate in a recirculation mode, a reclamation mode, and a high dosing mode with each mode providing a different rate of dosing/introduction of the liquid oxidizer into liquid 15 and controlling different flow paths through wash systems described herein. For example, in the recirculation mode, the PLC may introduce 0.20 ml per minute of 20% hydrogen peroxide per minute with a liquid flow rate of 85 gallons per minute; in the reclamation mode, the PLC may introduce 0.536 ml of 20% hydrogen peroxide per minute with a liquid flow rate of 30 gallons per minute; in the high dosing mode, the PLC may introduce 1.675 ml of 20% hydrogen peroxide per minute with a liquid flow rate of 30 gallons per minute; and a post-flush mode (used after filters 124, etc. are back flushed), the PLC may introduce 1.34 ml of 20% hydrogen peroxide per minute with a liquid flow rate of 30 gallons per minute. The rate of oxidizer output in each mode is different. For example, the rate of oxidizer output during the high dosing mode is 10 times the rate output during the recirculation mode. Ratios other than 10:1 may be provided, such as 5:1, 8:1, 12:1 20:1, etc. may be provided. The rate of oxidizer output during the high dosing mode is 2 times the rate output during the reclamation mode. Ratios other than 2:1 maybe provided, such as 1.5: 3:1, 4:1, 8:1, 12:1 20:1, etc. may be provided.

When in the recirculation mode, a valve(s) (not shown) controls the flow of oxidized liquid 15A to circulate liquid 15A through the recirculation loops, such as recirculation loop 26, without flowing through the reclamation loop, such as reclamation loop 28. When in the reclamation mode, the valve(s) control the flow of oxidized liquid 15A to circulate liquid 15A through the reclamation loops, such as reclamation loop 28, without flowing through the recirculation loop, such as recirculation loop 26. When in the high dosing mode, the valve(s) control the flow of oxidized liquid 15A to circulate liquid 15A through the reclamation loops, such as reclamation loop 28 to provide highly oxidized liquid 15 A throughout the wash systems to stop anaerobic reactions that create hydrogen sulfide. During low vehicle volume operating times (rainy days, evenings, etc., recirculation mode and reclamation modes periodically runs to circulate oxidized liquid 15A throughout the systems. The systems are configured to detect when a vehicle hasn't been washed in 4 minutes (as detected by conveyor operation). If no vehicle has been washed during this time span, the systems cycles through the recirculation mode and reclamation modes until a vehicle is detected. For example, every 45 minutes during a slow time (i.e. no vehicles are being washed), the systems runs for 30 minutes in recirculation mode, then runs for 10 minutes in reclamation mode, and 5 minutes the system shuts down/goes into an off mode. When a vehicle enters the systems, the systems switch to the reclamation mode to supply liquids 15A for spraying the vehicle, etc.

According to one embodiment, the PLC includes maintenance screens monitoring readings supplied by at least one sensor 21, pressure gauges 223′, 223″. Maintenance screens may display readings supplied by other sensors measuring on/off cycles, pump hours, system faults, such as low flow, no flush, motor fault, etc. According to one embodiment, readings displayed by maintenance screens may be remote connection capable.

According to the present disclosure, aerator 246, and other aerators discussed herein, may introduce air bubbles with a diameter less than or equal to 2 mm into liquid 15. The 2 mm diameter air bubbles have a surface area to volume ratio of three/mm. 0.05 mm diameter air bubbles have a surface area to volume ratio of sixty/mm. In other embodiments, aerator 246 may include a sub-micron porous block (not shown). A 5 micron bubble will producing air bubbles with a surface area to volume ratio of 30,000 for a 5 micron porous block.

Air bubbles are introduced into liquid 15 to increase the efficiency of dissolved oxygen. Oxygen transfer is increased when bubbles stay in the solution longer and bubbles stay in the solution longer by reducing the bubble velocity to the surface by reducing the size of the bubble.

According to the present disclosure, at least one pump 248, and other pumps discussed herein, may include a grinder. At least one pump 248 and the grinder cooperate to allow at least one pump 248 to be positioned in series of tanks 220 such that material is pumped through recirculation loop 26 and reclamation loop 28. The grinder can be placed in the series of tanks 220 to prevent problems related to the loss of priming. The grinder can eliminate the need for pre-filters requiring routine maintenance as the absence of a pre-filter allows the pump 248 to ingest neutrally buoyant material, such as fibers, paper, etc. Neutrally buoyant materials are materials that have about the same density as liquid 15A, such as materials that are within 15% of the density of liquid 15A.

According to the present disclosure, basin 18, and other basins discussed herein, are self-cleaning. Recirculation loop 26 provides a high flow of oxidized liquids 15A below conveyor 14. Tapered basin sides 219 and basin trough 280 cooperate to increase the flow rate and turbulence of liquids 15 as liquids 15 travel down sloped basin bottom 217. The preferred velocity of liquids 15 may be between 2 and 4 m/s to allow for effective self-cleaning without erosion of the basin. The preferred flow rate of liquids 15A may also be 85 gallons per min for effective cleaning without erosion of the basin.

According to an alternative embodiment, pump 248 located in third tank 220C may be a variable frequency drive (VFD) to vary pump speed, resulting in variance in the flow rate of liquid 15 flowing through either reclamation loop 28 and/or recirculation loop 26. Using a VFD may reduce electrical power consumption.

By varying the flow rate, the creation of filtered water provided can be adjusted to meet system demand. According to one embodiment, the flow rate may be varied based on the demand for filtered water. For example, tank 230 may include a non-binary/proportional pressure sensor 334 to detect the pressure in the bottom of tank 230 as shown in FIG. 7 with the level/height of water of tank 230 being determined by the pressure at the bottom of 230 (i.e. height=pressure/density of water/acceleration due to gravity). According to alternative embodiments, other types of non-binary/proportional liquid level sensors may be used, including a series of binary sensors. If tank 230 is full, then pump 248 may be turned off when in the reclamation mode. If tank 230 is at or near empty, then pump 248 may be run at its maximum flow rate. If tank 230 is between empty and full, then pump 248 may be run proportional to the level of tank 230, running with higher flow when tank 230 is lower and lower flow when tank 230 is higher. To determine the flow rate of filtered liquid 15 3 the level of fluid 15 in tank 230, the speed/output of pump 248 is adjusted up or down until flow sensor 336 senses that pump 248 is providing the desired flow rate to tank 230. For example, if flow sensor 336 senses that the flow rate is less than the desired flow rate based on the level of liquid 15 in tank 230, the speed/output of pump 248 will be increased. If flow sensor 336 senses that the flow rate is greater than desired flow rate based on the level of liquid 15 in tank 230, the speed/output of pump 248 will be decreased.

According to another alternative embodiment, level sensor 334 may detect when fluid 15 is below a point as are result of pump 248 being unable to provide adequate fluid 15 to tank 230. If sensor 334 detects fluid 15 below this point, municipal water is provided to tank 230 until sensor 334 detects fluid 15 is above this point.

When in the reclaim mode, liquid 15 which collects in the underground tank system consists of fresh water, fresh water with chemicals added, reverse osmosis water and filtered reclaim water. The amount of fresh water going into the underground tank system from the washing processes is based on the number of cars washed. Wastewater that overflows from third tank 220C goes into sanitary sewer system 236. As the amount of reclaim water utilized in the wash process increases, the amount of fresh water entering tank one 220A is reduced. The reclaim water 15 is preferably clear and odor free, but does have additional chemicals and biological dissolved solids which are being oxidized by the dosing chemical and aeration of tank two 220B.

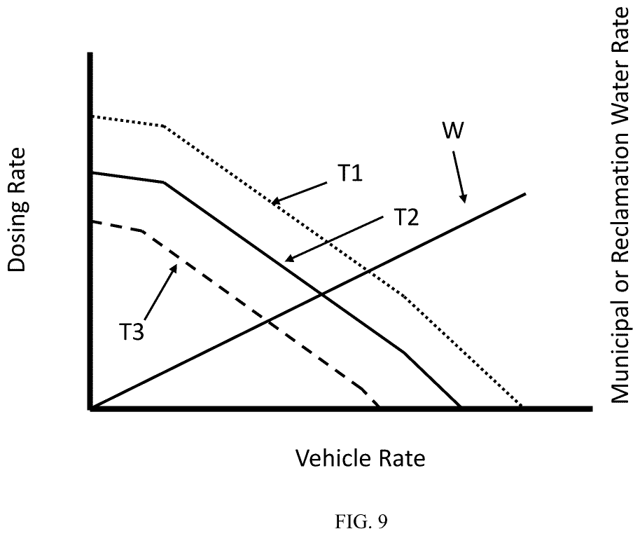

According to one embodiment of the present disclosure, the output of oxidizer system 22 is adjustable based on a rate of vehicles being washed. For example, if the vehicle rate is high (e.g. 200 vehicles/hour), the output or dosing of oxidizer system 22 may be a minimum, such as zero. Or, if the vehicle rate is low (e.g. 0 vehicles/hour), the output or dosing of oxidizer system 22 may be high. FIG. 9 gives three examples (T1, T2, and T3) of how dosing level could be reduced as the rate of vehicles through the wash increases or decreases with the dosing rate being higher when the vehicle rate is low and the dosing rate being lower when the vehicle rate is high. As the vehicle rate increases, the amount of municipal water introduced to the system increases as shown by W in FIG. 9. Similarly, the amount of reclaimed water used also increases.

The vehicle rate may be calculated in several ways. For example, the system could keep track of the number of vehicles that are washed over a given time period. For example, if 100 vehicles were washed over the most recent two-hour period, the vehicle rate would be 50 vehicles/hour. Based on this calculated vehicle rate, the dosing rate would be adjusted up or down. If after another two-hour period, 400 vehicles were washed, the vehicle rate would be 200 vehicles/hour. Based on this calculated vehicle rate, the dosing rate could be adjusted to a minimum, such as zero. If after another two-hour period, no vehicles were washed, the vehicle rate would be zero vehicles/hour. Based on this calculated vehicle rate, the dosing rate could be adjusted to a maximum output.

According to other embodiments, the vehicle rates may be calculated by determining the amount of liquid used by the system over a time period. For example, the amount of reclaim water (W in FIG. 9) used by the system over a period of time could be used to calculate the vehicle rate. For example, if 200 gallons of reclaim is used (as determined by flow sensor 336) by system over a one-hour period, the vehicle rate may be calculated in 200 gallons/hour. If the system uses 20 gallons of reclaim per vehicle wash, this vehicle rate may be converted to 10 vehicles/hour. Based on 200 gallons/hour (or 10 vehicles/hour), the dosing rate could be adjusted up or down. As discussed above, if the gallons/hour (or vehicles/hour) is zero, the dosing rate could be adjusted to the maximum output or if the gallons/hour (or vehicles/hour) is high enough, the dosing rate could be adjusted to a minimum, such as zero. Other amounts of liquid used over a time period could also be used, such as the amount of municipal water introduced into the system, the amount of cleaning chemical used, etc.

According to another embodiment, in addition to the vehicle rate, characteristics of liquid 15 could be used to determine the dosing rate. For example, on cold days, the temperature of liquid 15 may be low, requiring less dosing for each vehicle rate as shown in FIG. 9 for T3. On hot days, the temperature of liquid 15 may be high, requiring more dosing for each vehicle rate as shown in FIG. 9 for T1. On warm days, the temperature of liquid 15 may between low and high, requiring more dosing for each vehicle rate than on cold days and less dosing for each vehicle rate than on hot days as shown in FIG. 9 for T2. According to alternative embodiments, other characteristics such as, outdoor temperatures, tunnel temperatures, dissolved oxygen, pH, and other characteristics of liquid 15 may be used to determine the dosing rate in combination with the vehicle rate.

Those having ordinary skill in the art will recognize that numerous modifications can be made to the specific implementations described above. The implementations should not be limited to the particular limitations described. Other implementations may be possible.

I claim:

1. A vehicle wash system, comprising:
a plurality of nozzles configured to apply liquids to vehicles,
a vehicle conveyor configured to advance vehicles past the plurality of nozzles,
a basin positioned below the vehicle conveyor to collect liquids applied to the vehicle,
at least one pump configured to pump liquids to the plurality of nozzles, the at least one pump being configured to pump the liquids collected by the basin after application to the vehicles by the plurality of nozzles, and
an outlet positioned to provide liquids from the at least one pump directly to the basin.

2. The vehicle wash system of claim 1, wherein the outlet is positioned below the vehicle conveyor.

3. The vehicle wash system of claim 1, wherein the outlet directs the liquids down the basin.

4. The vehicle wash system of claim 1, further comprising a junction that directs the liquids from the at least one pump to the plurality of nozzles and the liquid from the at least one pump to the basin.

5. The vehicle wash system of claim 1, further comprising at least one tank positioned to receive liquids from the basin and the at least one pump is positioned in the tank.

6. The vehicle wash system of claim 5, further comprising a nano-bubbler aerator positioned in the at least one tank.

7. The vehicle wash system of claim 6, wherein the at least one tank includes a first tank, a second tank positioned to receive liquids from the first tank, and a third tank positioned to receive liquids from the second tank, the nano-bubbler is positioned in the second tank and the at least one pump is positioned in the third tank.

8. The vehicle wash system of claim 1, wherein the basin is sloped having a high end and a low end, the conveyor has an entry end to receive vehicles and an exit end positioned opposite the entry end, the low end of the basis is positioned nearer to the entry end of the conveyor than to the exit end of the basin, and the outlet is positioned to direct liquids toward the low end of the basin.

9. A vehicle wash system, comprising:
a plurality of nozzles configured to apply liquids to vehicles,
a vehicle conveyor configured to advance vehicles past the plurality of nozzles,
a basin positioned below the vehicle conveyor to collect liquids applied to the vehicle,
at least one pump configured to pump liquids to the plurality of nozzles, the at least one pump being configured to pump the liquids collected by the basin after application to the vehicles by the plurality of nozzles, and
a bypass providing liquids from the at least one pump to the basin, bypassing the plurality of nozzles.

10. The vehicle wash system of claim 9, further comprising a junction that directs the liquids from the at least one pump to the plurality of nozzles and the liquids to the bypass.

11. The vehicle wash system of claim 9, wherein the bypass is positioned downstream of the at least one pump and upstream of the plurality of nozzles.

12. The vehicle wash system of claim 9, wherein the plurality of nozzles, the basin, and the at least one pump cooperate to define a reclamation loop and the basin, the at least one pump, and bypass cooperate to define a recirculation loop.

13. The vehicle wash system of claim 12, wherein the liquids from the at least one pump flow through the recirculation loop and bypass the reclamation loop.

14. The vehicle wash system of claim 12, further comprising a filter, wherein the reclamation loop includes the filter and liquids from the at least one pump flow through the recirculation loop and bypass the filter in the reclamation loop.

15. A vehicle wash system, comprising:
a plurality of nozzles configured to apply liquids to vehicles,
a vehicle conveyor configured to advance vehicles past the plurality of nozzles at a vehicle rate,
at least one pump configured to pump liquids to the plurality of nozzles, the at least one pump being configured to pump the liquids from at least one tank positioned to receive the liquids after application to the vehicles by the plurality of nozzles, and
an adjustable oxidizer system in fluid communication with the liquids moved by the at least one pump to introduce a metered amount of oxidizer into the liquid and adjusting the metering based on the vehicle rate.
